(19) United States
(12) Patent Application Publication
(10) Pub. No.: US 2014/0218523 A1
(43) Pub. Date: Aug. 7, 2014

(54) BURGLARPROOF DEVICE

(71) Applicant: Ta-Tsun SU, New Taipei City (TW)

(72) Inventor: Ta-Tsun SU, New Taipei City (TW)

(21) Appl. No.: 13/760,360

(22) Filed: Feb. 6, 2013

(51) Int. Cl. B60R 25/30

(52) U.S. Cl. CPC B60R 25/305
USPC 348/148

(57) ABSTRACT

A burglarproof device for vehicle comprises a main body and at least one mobile communication device is disclosed. The main body has a control circuit connecting to detection units, camera units, audio module, and wireless communication and GPRS module. The mobile communication device has APP program for receiving the transmitted signal of the main body and controlling the function of the APP program; wherein the wireless communication and GPRS module store at least one series of number dedicated to the mobile communication device; wherein the detection unit drives the camera unit to record a video, the control circuit collects the video and translates the format of the video, and then the wireless communication and GPRS module dials the series of number of the mobile communication device when the stealing is occurred.

### BACKGROUND OF THE INVENTION

1. Field of the Invention

The present invention relates to a burglarproof device, particular to a burglarproof device for sensing theft event through a detection unit, transmitting the video to a smart phone of user, recording the video and then reporting to the police, so as to have function of anti theft and criminal trace.

2. Description of Related Art

People who park their vehicle in a parking lot normally enable car burglar alarm, to have the car burglar alarm ready for activation. When the theft event is occurred, the car burglar alarm can merely make some noise, without function of dealing with theft event and recording its video; not even mentioned of reporting to the police. In this manner, chasing the thief in time and tracing the clue of the theft event, for police to solve the criminal case, are not easily achieved. This would be a significant problem for the police and the vehicle industries which need to be addressed urgently.

### SUMMARY OF THE INVENTION

The primary object of the present invention is to provide a burglarproof device which can sense theft event through a detection unit, transmit the video to a smart phone of user, record the video and then report to the police; so that anti-theft and criminal trace are therefore achieved.

To achieve the above purposes, a burglarproof device is disclosed. The burglarproof device for vehicle comprises a main body and at least one mobile communication device. The main body has a control circuit connecting to a plurality of detection units disposed at car door of the vehicle, a plurality of camera units disposed at hidden site of the vehicle, a audio module for loading location of the vehicle, and a wireless communication and General Packet Radio Service (GPRS) module. The mobile communication device has APP program for receiving the transmitted signal of the main body and controlling the function of the APP program; wherein the wireless communication and GPRS module selectively store at least one series of number dedicated to the mobile communication device; wherein the detection unit drives the camera unit to record a video, the control circuit collects the video and translates the format of the video, and then the wireless communication and GPRS module dials the series of number of the mobile communication device when the stealing is occurred, so as to transmit the video signal to the mobile communication device, to store the video data in the mobile communication device, and to report the location of the vehicle through Global Position System (GPS) to the police for anti theft and criminal trace.

According to one embodiment of the burglarproof device, wherein the detection unit is magnet-spring type switch or pressure-activated type switch.

According to one embodiment of the burglarproof device, wherein the mobile communication device is smart phone, i-phone or tablet PC.

In short, the burglarproof device of the present invention incorporates wireless communicative module and detection unit to the vehicle, so as to detect theft event by the detection unit, to transmit the video signal to the mobile communication device, to store the video data in the mobile communication device, and to report to the police through the mobile communication device. Therefore the functions of anti-theft and criminal trace are achieved.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows one of application of the burglarproof device according the present invention;

FIG. 2 shows schematic diagram of the burglarproof device according the present invention;

FIG. 3 shows functional block of the burglarproof device according the present invention;

FIG. 4 shows mobile communication device of the burglarproof device according the present invention;

FIG. 5 shows another application of the burglarproof device according the present invention.

### DETAILED DESCRIPTION OF THE PREFERRED EMBODIMENTS

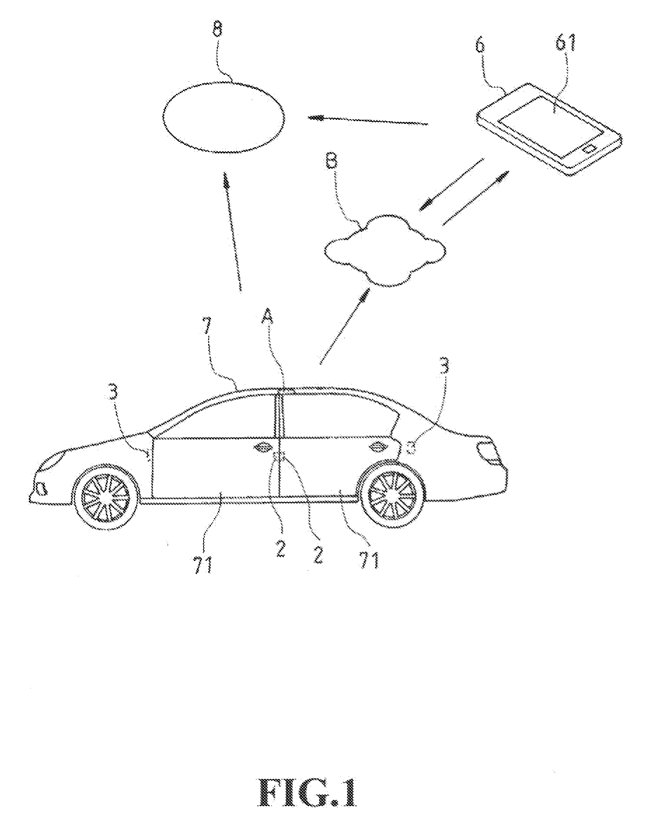

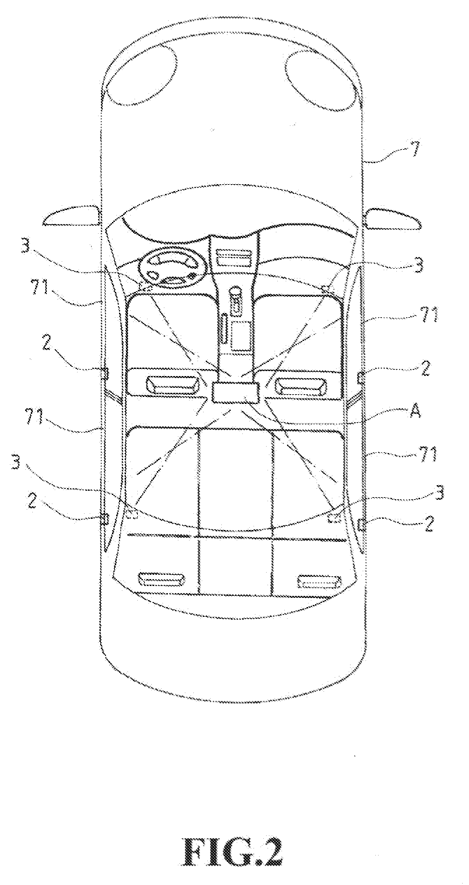

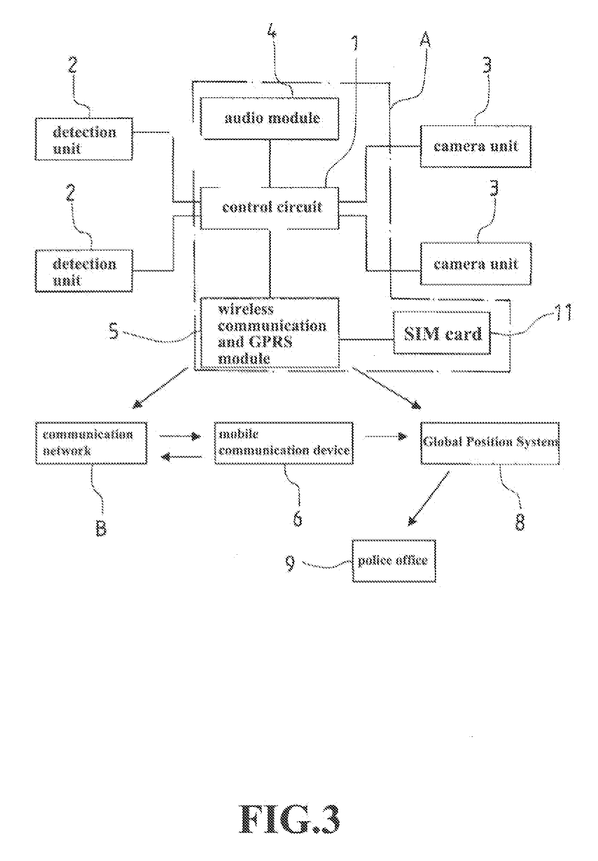

Please refer to FIG. 1˜FIG. 3, FIG. 1 shows one of application of the burglarproof device according the present invention; FIG. 2 shows schematic diagram of the burglarproof device according the present invention; FIG. 3 shows functional block of the burglarproof device according the present invention. As shown in the figures, the burglarproof device of the present invention comprises a main body A; the main body A has a control circuit 1, a plurality of detection units 2, a plurality of camera units 3, an audio module 4 and a wireless communication and General Packet Radio Service (GPRS) module 5. In the embodiment, the control circuit 1 connects to the detection units 2, camera units 3, audio module 4 and wireless communication and GPRS module 5. Besides, the detection unit 2 can be magnet-spring type switch or pressure-activated type switch; the wireless communication and GPRS module 5 can be wireless network. WiFi network, high frequency RX/TX circuit, etc. In preferable embodiment, the wireless communication and GPRS module 5 is communication network B including a Subscriber Identity Module (SIM) disposed inside. In this manner, the control circuit A may be a sort of communicative apparatus with at least one series of number dedicated to specific mobile communicative function. Therefore some given number may be input and loaded into a mobile communication device 6 through the control circuit 1.

The mobile communication device 6 has APP program for receiving the transmitted signal of the main body A, in which the APP program may control every function of the mobile communication device 6. In preferable embodiment, the mobile communication device 6 may be smart phone, i-phone or tablet PC, etc.

The aforementioned configuration of the burglarproof device may be integrated into the vehicle 7; moreover, the plurality of detection units 2 may be disposed at car door 71 of the vehicle 7, and the plurality of camera units 3 may be disposed at hidden site of the vehicle 7; therefore people/user may load location of the vehicle 7 through the audio module 4. When the stealing of the vehicle 7 is occurred, the detection unit 2 may drive the camera unit 3 to record a video, the control circuit 1 may collect the video and translate the format of the video, and then the wireless communication and GPRS module 5 may dial the series of number of the mobile communication device 6, so as to transmit the video signal through a communication network B to the mobile communication device 6, to store the video data in the mobile communication device 6, and to report the location of the vehicle 7 through Global Position System (GPS) 8 to the police for anti theft and criminal trace.

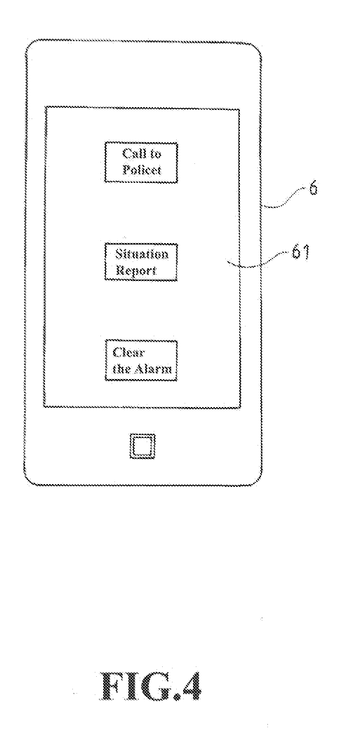

Referring to FIG. 4, as well as FIG. 1˜FIG. 3, the mobile communication device 6 according to the present invention has APP program to receive the transmitted signal of the main body A, so that the mobile communication device 6 has all kinds of APP functions. In the embodiment of FIG. 4, the police telephone (e.g. 110 in Taiwan, 911 in America) may be saved in the mobile communication device 6 in advance. When the transmitted signal of the main body A is received by the mobile communication device 6, the mobile communication device 6 may reveal at least three conditions (options to be chosen), including “Call to Police”, “Situation Report” and “Clear the Alarm”. At least three conditions could be:

1.“Situation Report” activating the surveillance of the theft event through the screen 61 and then recording the video, as well as transmitting the GPRS to the owner of the vehicle;

2.“Call to Police” reporting the theft event to the police through the dialing of the mobile communication device 6, and then transmitting the message (including location of the theft and movement of the stolen vehicle 7) through the wireless communication and GPRS module 5 and the GPS 8 to the police office 9, or even sending a news brief to the police office 9; so that the staff in the police office may oversee the stolen vehicle 7 from the GOOGLE map, thus may analyze the escape route of the stolen vehicle 7 and then help catch the thief;

3. “Clear the Alarm” abandoning the alarm, relieving the situation, and then returning the main body A to the condition of standby.

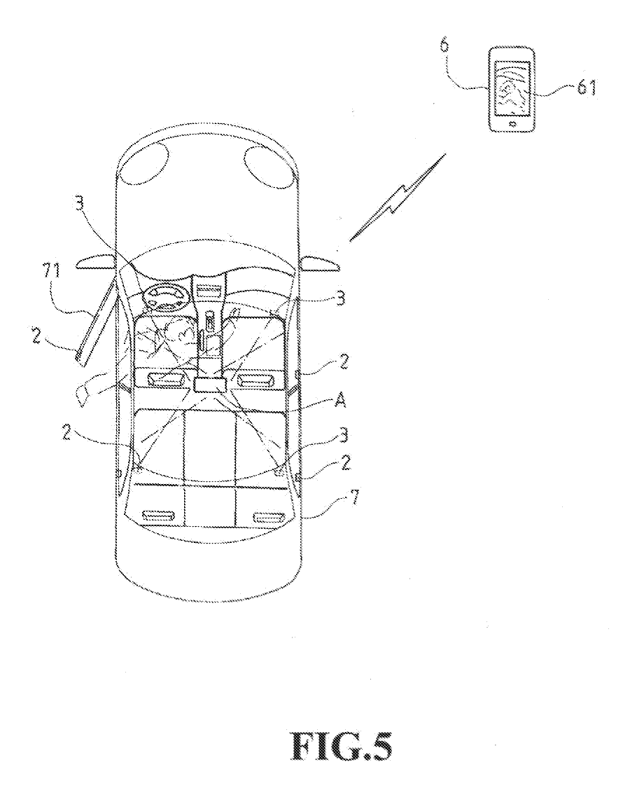

Please refer to FIG. 5, accompanying by the FIG. 3, when a theft event is occurred and the car door 71 of the vehicle 7 is illegally broken through, an unusual signal may be detected by the detection unit 2 disposed at the car door 71; meanwhile the control circuit 1 drives the camera unit 3 to record the video, collects the video and translates the format of the video, and then the wireless communication and GPRS module 5 automatically dials the stored series of number of the mobile communication device 6. In this manner, the video may be transmitted to the mobile communication device 6 through the communication network B, thus the video can be seen in the screen 61 of the mobile communication device 6. Therefore reporting to the police and recording the video can be optional fulfilled, and transmitting the location of the stolen vehicle 7 through the GPS 8 to the police office 9 is thus achieved. The functions of anti-theft and criminal trace are therefore achieved. In this manner, the staff in the police office may simultaneously oversee the stolen vehicle 7 from the GOOGLE map, and thus may analyze the escape route of the stolen vehicle 7 and then help catch the thief.

Summarily, the burglarproof device of the present invention incorporates wireless communicative module and detection unit to the vehicle, so as to detect theft event by the detection unit, to transmit the video signal to the mobile communication device, to store the video data in the mobile communication device, and to report to the police through the mobile communication device. Therefore the functions of anti-theft and criminal trace are achieved.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A burglarproof device for vehicle, comprising:
a main body having a control circuit connecting to a plurality of detection units disposed at car door of the vehicle, a plurality of camera units disposed at hidden site of the vehicle, a audio module for loading location of the vehicle, and a wireless communication and General Packet Radio Service (GPRS) module;
at least one mobile communication device, having APP program for receiving the transmitted signal of the main body and controlling the function of the APP program, wherein the wireless communication and GPRS module selectively store at least one series of number dedicated to the mobile communication device;
wherein the detection unit drives the camera unit to record a video, the control circuit collects the video and translates the format of the video, and then the wireless communication and GPRS module dials the series of number of the mobile communication device when the stealing is occurred, so as to transmit the video signal to the mobile communication device, to store the video data in the mobile communication device, and to report the location of the vehicle through Global Position System (GPS) to the police for anti theft and criminal trace.

2. The burglarproof device for vehicle according to claim 1, wherein the detection unit is magnet-spring type switch or pressure-activated type switch.

3. The burglarproof device for vehicle according to claim 1, wherein the mobile communication device is smart phone, i-phone or tablet PC.
